(19) United States
(12) Patent Application Publication
(10) Pub. No.: US 2007/0243331 A1
(43) Pub. Date: Oct. 18, 2007

(54) Heat sealable compositions from aqueous dispersions

(75) Inventors: Gary M. Strandburg, Mount Pleasant, MI (US); Brad M. Moncla, Lake Jackson, TX (US); Matt J. Kalinowski, Freeland, MI (US)

Correspondence Address: OSHA LIANG L.L.P., 1221 MCKINNEY STREET, SUITE 2800, HOUSTON, TX, 77010, US

(73) Assignee: DOW GLOBAL TECHNOLOGIES INC., Midland, MI (US)

(21) Appl. No.: 11/706,136

(22) Filed: Feb. 13, 2007

Related U.S. Application Data
(60) Provisional application No. 60/774,933, filed on Feb. 17, 2006.

(51) Int. Cl. B05D 3/02; C08F 30/04; C08J 3/215

(52) U.S. Cl. 427/385.5; 523/334; 526/240

(57) ABSTRACT

A dispersion that includes (A) an ethylene-acid copolymer; (B) a neutralizing agent; and (C) water, wherein the neutralizing agent is present in an amount sufficient to neutralize greater than 55% by weight of the carboxyl groups in component (A) is disclosed. Also, a dispersion that includes (A) an ethylene-acid copolymer; (B) a strong base, having a pKa of about 10 or greater; (C) water, wherein the strong base is the sole neutralizing agent and is present in an amount sufficient to neutralize greater than 55% by weight of the carboxyl groups in component (A) is disclosed.

### CROSS-REFERENCE TO RELATED APPLICATION

This application claims priority to U.S. Provisional Patent Application No. 60/774,933, filed Feb. 17, 2006, the disclosure of which is incorporated herein by reference.

### BACKGROUND OF INVENTION

1. Field of the Invention

The present invention relates generally to aqueous dispersions and dispersion compounds that are useful as heat sealable compounds.

2. Background Art

One particular use for coatings made from dispersions is in packaging and storage container applications. To be useful, a balance of performance properties, such as low heat seal initiation temperature, a high hot tack strength, a broad hot sealing window, good interlayer adhesion, and a high softening point, is desirable.

The commercial importance of balanced sealant properties is well understood. That is, low heat seal initiation temperatures are important for improved sealing speeds and reduced energy utilization. A broad sealing window is important for insuring package integrity, sealing equipment flexibility and low package leakage rates.

U.S. Pat. Nos. 6,852,792 and 5,419,960 disclose prior art compositions for formulating heat sealable compounds. Those patents are incorporated herein by reference in their entirety.

Good interlayer adhesion is also important for good package integrity as well as good package or container aesthetics. High softening points or temperatures are desired where goods are packaged at elevated temperatures such as in hot-fill applications. Traditionally, when attempting to achieve balanced sealant properties, enhancement of one particular resin property has required some sacrifice with respect to another important property.

For instance, with ethylene alpha-olefin polymers, low heat seal initiation temperatures are typically achieved by increasing the comonomer content of the resin. Conversely, high Vicat softening points and low levels of n-hexane extractives are typically achieved by decreasing the comonomer content of the resin. Accordingly, lowering the heat seal initiation temperature typically results in proportionally reduced Vicat softening temperature and proportionally increased extractable level. U.S. Pat. No. 5,874,139, which is assigned to the assignee of the present invention and is expressly incorporated herein by reference in its entirety, provides a general discussion of polyolefins in packaging applications. Several important multi-layer packaging and storage structures consist of a polypropylene layer, particularly, a biaxially oriented polypropylene homopolymer (BOPP) base or core layer. Often, BOPP structures utilize polypropylene copolymers and terpolymers as sealant materials (and/or adhesive layers) to insure good interlayer adhesion to the BOPP base layer. While polypropylene copolymers and terpolymers do indeed provide good interlayer adhesion to BOPP base layers as well as good heat seal strength performance, these copolymers and terpolymers sometimes exhibit undesirably high heat seal initiation temperatures.

Other materials have also been used as sealant materials for multi-layer packaging and storage structures. However, in general, known sealant materials do not provide the desired overall property balance and/or process flexibility desired by converters and packagers.

### SUMMARY OF INVENTION

In one aspect, embodiments disclosed herein relate to a dispersion that includes (A) an ethylene-acid copolymer; (B) a neutralizing agent; and (C) water, wherein the neutralizing agent is present in an amount sufficient to neutralize greater than 80% by weight of the carboxyl groups in component (A).

In another aspect, embodiments disclosed herein relate to a dispersion that includes (A) an ethylene-acid copolymer; (B) a strong base, having a pKa of about 10 or greater; and (C) water, wherein the strong base is the sole neutralizing agent and is present in an amount sufficient to neutralize greater than 55% by weight of the carboxyl groups in component (A).

In another aspect, the present invention relates to ethylene acrylic acid or methacrylic acid co-polymer aqueous dispersions having greater than 20% by weight solids, greater than 55% by weight neutralized, a viscosity less than 1000 cps, and that are prepared by direct neutralization with a strong base (pKa greater than 10) without requiring a weak base at any step in the process.

Other aspects and advantages of the invention will be apparent from the following description and the appended claims.

### BRIEF DESCRIPTION OF DRAWINGS

FIG. 1 shows an extruder that may be used in formulating dispersions in accordance with embodiments of the present invention.

FIG. 2 graphically compares the heat seal strength as a function of heat seal temperature for coated film samples according to embodiments disclosed herein and a comparative coated film sample.

### DETAILED DESCRIPTION

Embodiments of the present invention relate to aqueous dispersions, and compounds made from aqueous dispersions that are useful as heat sealable compositions. Dispersions used in embodiments of the present invention comprise water, (A) an ethylene-acid copolymer, and (B) a neutralizing agent, wherein the neutralizing agent is present in an amount sufficient to neutralize greater than 80% by weight of the carboxyl groups in component (A). These are discussed in more detail below.

Base Polymer

In accordance with this invention, a coated film is provided wherein a substrate, such as a polymer film, e.g., oriented polypropylene, is coated with a composition comprising a copolymer of, for example, about 65 to 95 wt. % of ethylene and about 5 to 35 wt. % of acrylic or methacrylic acid (an “ethylene-acid copolymer”) based on the weight of the polymer, and in which, for example, greater than about 80% of the carboxyl groups are neutralized with metal ions from Group Ia, IIa, or IIb of the Periodic Table (CAS version).

The ethylene-acid copolymer utilized in the compositions of this invention may be a copolymer of, for example, about 65 to 95 wt. %, preferably about 75 to 85 wt. % of ethylene, and, for example, about 5 to 35 wt. %, preferably about 15 to 25 wt. % of acrylic acid (AA) or methacrylic acid (MA). The ethylene-acid copolymer may have a number average molecular weight (Mn) of, for example, about 2,000 to 50,000, preferably about 4,000 to 10,000.

The ethylene-acid copolymer may be supplied as a solution or fine dispersion of an ammonium salt of the copolymer in an ammoniacal water solution. When the ethylene-acid copolymer is dried, ammonia is given off and then ionized and water sensitive carboxylate groups are converted to largely unionized and less water sensitive free carboxyl groups. However, in other embodiments, neutralization may occur without the presence of any ammonia. In practicing this invention, there is added to the solution or dispersion of the ethylene-acid copolymer an amount of ions of at least one metal from Group Ia, IIa, or IIb of the Periodic Table, preferably, sodium, potassium, lithium, calcium or zinc ions, and most preferably sodium ions, e.g., in the form of their hydroxides. The quantity of such metallic ions may be in the range sufficient to neutralize, for example, greater than 80% by weight, preferably about 90% to 150% by weight of the total carboxyl groups in the copolymer. In other words, excess strong base may be added in some cases. In other embodiments, strong base may be added in an amount sufficient to neutralize up to 200% by weight or higher may be added. In other embodiments strong base may be added in an amount sufficient to neutralize 55%, 60%, 65%, 70%, 75%, 85%, 90%, 95%, 100%, 105%, 110%, 115%, 120%, 125%, 135% by weight of the carboxyl groups in the polymer. The presence of such metallic ions has been found to result in an improvement in certain properties, e.g., coefficient of friction (COF), hot tack, and blocking, without an unacceptable sacrifice of other properties, e.g., low minimum seal temperatures (MST).

Thus, embodiments of the present invention employ partially to fully neutralized ethylene-acid copolymers. As noted above, polymers useful for embodiments of the present invention include ethylene-acrylic acid (EAA) and ethylene-methacrylic acid (EMA) copolymers, such as those available under the trademarks PRIMACOR™ (trademark of The Dow Chemical Company), NUCREL™ (trademark of E. I. DuPont de Nemours), and ESCOR™ (trademark of ExxonMobil) and described in U.S. Pat. Nos. 4,599,392, 4,988,781, and 5,938,437, each of which is incorporated herein by reference in its entirety. Other ethylene-carboxylic acid copolymers may also be used. Those having ordinary skill in the art will recognize that a number of other polymers may also be used.

Neutralizing Agent

Embodiments of the present invention use a strong base as a neutralizing agent. In selected embodiments, the strong base has a pKa of greater than about 10. In selected embodiments, the strong base comprises a metal base, wherein the metal is at least one metal selected from groups Ia, IIa, or IIb of the Periodic Table. In selected embodiments, the stabilizing agent may be potassium hydroxide. In other embodiments, the present invention may use a group Ia salt as the strong base, such as sodium carbonate, potassium silicate, sodium phosphate, or the like.

In certain embodiments, neutralization of the base polymer is performed such that greater than about 80% by weight of the neutralizable groups are neutralized. In other embodiments, 90%-150% by weight may be neutralized. In other embodiments strong base may be added in an amount sufficient to neutralize 55%, 60%, 65%, 70%, 75%, 85%, 90%, 95%, 100%, 105%, 110%, 115%, 120%, 125%, 135% by weight of the carboxyl groups in the polymer. In some embodiments, mixtures of strong bases, or mixtures of strong and weak bases, may be used for higher neutralization percentages. Again, as used herein, a “strong base” refers to a compound or compounds having a pKa of about 10 or greater. For example, for EAA, the neutralizing agent may be potassium hydroxide. Other neutralizing agents may include lithium hydroxide or sodium hydroxide, for example. Those having ordinary skill in the art will appreciate that the selection of an appropriate neutralizing agent depends on the specific composition formulated, and that such a choice is within the knowledge of those of ordinary skill in the art.

In still other embodiments, neutralization of the base polymer is performed such that greater than about 55% by weight of the neutralizable groups are neutralized.

Additional surfactants that may be useful in the practice of the present invention include cationic surfactants, anionic surfactants, or a non-ionic surfactants. Examples of anionic surfactants include sulfonates, carboxylates, and phosphates. Examples of cationic surfactants include quaternary amines. Examples of non-ionic surfactants include block copolymers containing ethylene oxide and silicone surfactants. Surfactants useful in the practice of the present invention may be either external surfactants or internal surfactants. External surfactants are surfactants that do not become chemically reacted into the polymer during dispersion preparation. Examples of external surfactants useful herein include salts of dodecyl benzene sulfonic acid and lauryl sulfonic acid. Internal surfactants are surfactants that do become chemically reacted into the polymer during dispersion preparation. An example of an internal surfactant useful herein includes 2,2-dimethylol propionic acid and its salts.

Formulation of Dispersion

In a specific embodiment, EAA is melt-kneaded in an extruder along with water and a metal base neutralizing agent, such as potassium hydroxide, to form a dispersion compound. Those having ordinary skill in the art will recognize that a number of other metal base neutralizing agents may be used.

Any melt-kneading means known in the art may be used. In some embodiments, a kneader, a BANBURY® mixer, single-screw extruder, or a multi-screw extruder is used. A process for producing the dispersions in accordance with the present invention is not particularly limited. One preferred process, for example, is a process comprising melt-kneading the above-mentioned components according to U.S. Pat. No. 5,756,659 and U.S. Pat. No. 6,455,636. These patents are incorporated by reference in their entirety.

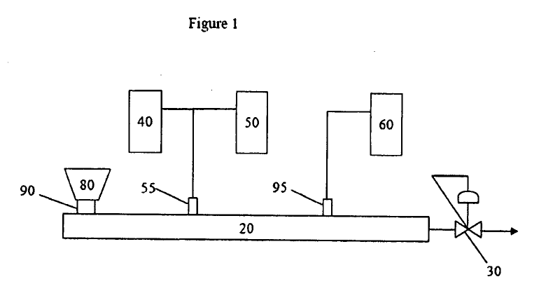

FIG. 1 schematically illustrates an extrusion apparatus that may be used in embodiments of the invention. An extruder 20, in certain embodiments a twin screw extruder, is coupled to a back pressure regulator, melt pump, or gear pump 30. Embodiments also provide a base reservoir 40 and an initial water reservoir 50, each of which includes a pump (not shown). Desired amounts of base and initial water are provided from the base reservoir 40 and the initial water reservoir 50, respectively. Any suitable pump may be used, but in some embodiments a pump that provides a flow of about 150 cc/min at a pressure of 240 bar is used to provide the base and the initial water to the extruder 20. In other embodiments, a liquid injection pump provides a flow of 300 cc/min at 200 bar or 600 cc/min at 133 bar. In some embodiments, the base and initial water are preheated in a preheater.

Resin in the form of pellets, powder or flakes is fed from the feeder 80 to an inlet 90 of the extruder 20 where the resin is melted or compounded. In some embodiments, the dispersing agent is added to the resin through and along with the resin, and in other embodiments, the dispersing agent is provided separately to the twin screw extruder 20. The resin melt is then delivered from the mix and convey zone to an emulsification zone of the extruder where the initial amount of water and base from the reservoirs 40 and 50 is added through inlet 55. In some embodiments, dispersing agent may be added additionally or exclusively to the water stream. In some embodiments, the emulsified mixture is further diluted with additional water added through inlet 95 from reservoir 60 in a dilution and cooling zone of the extruder 20. Typically, the dispersion is diluted to at least 30 weight percent water in the cooling zone. In addition, the diluted mixture may be diluted any number of times until the desired dilution level is achieved. In some embodiments, water is not added into the twin screw extruder 20 but rather to a stream containing the resin melt after the melt has exited from the extruder. In this manner, steam pressure build-up in the extruder 20 is eliminated.

Advantageously, by using an extruder in certain embodiments, the base polymer and the stabilizing agent may be blended in a single process to form a dispersion. Also, advantageously, by using one or more of the stabilizing agents listed above, the dispersion is stable with respect to the additives.

However, in other embodiments of the present invention, other techniques for forming a dispersion may be used. In particular, in certain embodiments, the components of the dispersion may be placed in a processing tank, and heated to form a dispersion. In embodiments of the present invention, the dispersion may have a Brookfield viscosity of less than 1000 cP (RV3 spindle, 21.5° C., 50 rpm). In other embodiments, the viscosity may be less than about 500 cP. In selected embodiments, the total solids loading (i.e., of base polymer plus strong base plus additives) may be greater than about 20% by weight. In other embodiments the solids loading may be greater than about 25% by weight.

Additives

In addition to the partially neutralized ethylene-acid copolymer, the coatings of this invention may further contain a relatively large particle size microcrystalline wax as an anti-blocking agent. The microcrystalline wax may be present in the coating in an amount of, for example, about 2 to 12 parts per hundred of base polymer, preferably about 3 to 5 parts per hundred of base polymer, wherein the wax particles have an average size in the range of, for example, about 0.1 to 0.6 microns, preferably about 0.12 to 0.30 microns.

In addition to functioning as an anti-blocking material, the microcrystalline wax when incorporated into the coatings of the present invention also functions to improve the “cold-slip” properties of the films coated therewith, i.e., the ability of a film to satisfactorily slide across surfaces at about room temperatures.

The coatings of this invention also may contain fumed silica for the purpose of further reducing the tack of the coating at room temperature. The fumed silica is composed of particles that are agglomerations of smaller particles and have an average particle size of, for example, about 2 to 9 microns, preferably about 3 to 5 microns, and is present in the coating in an amount, for example, of about 0.1 to 2.0 parts per hundred of base polymer, preferably about 0.2 to 0.4 parts per hundred of base polymer.

Other optional additives that may be used, include particulate materials, such as talc, which may be present in an amount, for example, of about 0 to 2 parts per hundred of base polymer, cross-linking agents, such as melamine formaldehyde resins, which may be present in an amount, for example, of 0 to 20 parts per hundred of base polymer, and anti-static agents, such as poly(oxyethylene) sorbitan monooleate, which may be present in an amount, for example, of about 0 to 6 parts per hundred of base polymer.

Coating Application Conditions

After the dispersion has been produced, it may be coated on to a substrate. With respect to the coating thickness, the thickness of the applied coating is important in controlling the hot tack and seal strength of the finished film. A coating thickness of 1 to 2 microns is typically needed to generate a seal strength>200 g/in., which is a suitable strength for a packaging application. Preferred thickness for the dried coating is from 0.5 to 75 microns. In certain embodiments, a coating thickness for the dried coating is from 0.5 to 25 microns. In other embodiments, a coating thickness for the dried coating is from 0.75 to 5, or from 0.75 to 2, microns.

In some embodiments, the dried coating may have a seal strength of at least 150 g/in at a seal temperature of 70° C. and at a thickness of between 1 and 2 microns. In other embodiments, the dried coating may have a seal strength of at least 160 g/in at a seal temperature of 70° C. and at a thickness of between 1 and 2 microns; at least 170 g/in in other embodiments; and at least 180 g/in in yet other embodiments.

In other embodiments, the dried coating may have a seal strength of at least 300 g/in at a seal temperature of 80° C. and at a thickness of between 1 and 2 microns. In other embodiments, the dried coating may have a seal strength of at least 400 g/in at a seal temperature of 80° C. and at a thickness of between 1 and 2 microns; at least 450 g/in in other embodiments; and at least 500 g/in in yet other embodiments.

Embodiments of the present invention are particularly suited for use with oriented substrates. However, the substrates may or may not be oriented, depending on the application. Those having ordinary skill in the art will appreciate that any number of substrates may be used. “Solid state orientation” herein refers to the orientation process carried out at a temperature higher than the highest Tg (glass transition temperature) of resins making up the majority of the structure and lower than the highest melting point, of at least some of the film resins, that is at a temperature at which at least some of the resins making up the structure are not in the molten state. Solid state orientation may be contrasted to “melt state orientation” that is including hot blown films, in which stretching takes place immediately upon emergence of the molten polymer film from the extrusion die.

“Solid state oriented” herein refers to films obtained by either coextrusion or extrusion coating of the resins of the different layers to obtain a primary thick sheet or tube (primary tape) that is quickly cooled to a solid state to stop or slow crystallization of the polymers, thereby providing a solid primary film sheet, and then reheating the solid primary film sheet to the so-called orientation temperature, and thereafter biaxially stretching the reheated film sheet in an orientation process (for example a trapped bubble method) or using a simultaneous or sequential tenter frame process, and finally rapidly cooling the stretched film to provide a heat shrinkable film. In the trapped bubble solid state orientation process the primary tape is stretched in the transverse direction (TD) by inflation with air pressure to produce a bubble, as well as in the longitudinal direction (LD) by the differential speed between the two sets of nip rolls that contain the bubble. In the tenter frame process the sheet or primary tape is stretched in the longitudinal direction by accelerating the sheet forward, while simultaneously or sequentially stretching in the transverse direction by guiding the heat softened sheet through a diverging geometry frame.

Substrates such as film and film structures particularly benefit from the novel coating methods and coating compositions described herein and those substrates may be made using conventional hot blown film fabrication techniques or other biaxial orientation processes such as tenter frames or double bubble processes. Conventional hot blown film processes are described, for example, in The Encyclopedia of Chemical Technology, Kirk-Othmer, Third Edition, John Wiley & amp; Sons, New York, 1981, Vol. 16, pp. 416-417 and Vol. 18, pp. 191-192. Biaxial orientation film manufacturing process such as described in a “double bubble” process as in U.S. Pat. No. 3,456,044 (Pahlke), and the processes described in U.S. Pat. No. 4,352,849 (Mueller), U.S. Pat. No. 4,597,920 (Golilce), U.S. Pat. No. 4,820,557 (Warren), U.S. Pat. No. 4,837,084 (Warren), U.S. Pat. No. 4,865,902 (Golike et al.), U.S. Pat. No. 4,927,708 (Herran et al.), U.S. Pat. No. 4,952,451 (Mueller), U.S. Pat. No. 4,963,419 (Lustig et al.), and U.S. Pat. No. 5,059,481 (Lustig et al.), may also be used to make substrates for coating by the novel coating methods and coating compositions described herein. The substrate film structures may also be made as described in a tenter frame technique, such as that used for oriented polypropylene.

Other multi-layer film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 31-80 (published by TAPPI Press (1992)).

The substrate films may be monolayer or multi-layer films. The substrate film to be coated may also be coextruded with other layer(s) or the film may be laminated onto another layer(s) in a secondary operation to form the substrate to be coated, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, Jun. 15-17(1981), pp. 211-229. If a monolayer substrate film is produced via tubular film (that is, blown film techniques) or flat die (that is, cast film) as described by K. R. Osborn and W. A. Jenkins in “Plastic Films, Technology and Packaging Applications” (Technomic Publishing Co., Inc. (1992) ), then the film must go through an additional post-extrusion step of adhesive or extrusion lamination to other packaging material layers to form a. multi-layer structure to be used as the substrate. If the substrate film is a coextrusion of two or more layers (also described by Osborn and Jenkins), the film may still be laminated to additional layers of packaging materials, depending on the other physical requirements of the final film.

“Laminations Vs. Coextrusion” by D. Dumbleton (Converting Magazine (September 1992)), also discusses lamination versus coextrusion. Monolayer and coextruded films may also go through other post extrusion techniques, such as a biaxial orientation process.

Extrusion coating is yet another technique for producing multi-layer film structures as substrates to be coated using the novel coating methods and coating compositions described herein. The novel coating compositions comprise at least one layer of the coated film structure. Similar to cast film, extrusion coating is a flat die technique.

The films and film layers of this invention are useful in vertical- or horizontal-form-fill-seal (HFFS or VFFS) applications. Relevant patents describing these applications include U.S. Pat. Nos. 5,228,531, 5,360,648, 5,364,486, 5,721,025, 5,879,768, 5,942,579, and 6,117,465.

Embodiments of the present invention may also be useful in multi-layer films. In this case, at least one disclosed composition is used to form at least one layer of the total multi-layer film structure. Other layers of the multi-layer structure may include but are not limited to barrier layers, and/or tie layers, and/or structural layers.

Various materials may be used for these layers, with some of them being used as more than one layer in the same film structure. Some of these materials include: foil, nylon, ethylene/vinyl alcohol (EVOH) copolymers, polyvinylidene chloride (PVDC), polyethylene terephthalate (PET), polypropylene, oriented polypropylene (OPP), ethylene/vinyl acetate (EVA) copolymers, ethylene/acrylic acid (EAA) copolymers, ethylene/methacrylic acid (EMAA) copolymers, LLDPE, HDPE, LDPE, nylon, graft adhesive polymers (for example, maleic anhydride grafted polyethylene), and paper. Generally, the multi-layer film structures comprise from 2 to 7 layers.

Substrate films may be made by cast extrusion (for monolayer films) or coextrusion (for multi-layer films) by techniques well known in the art. The films may be quenched, irradiated by electron beam irradiation at a dosage of between 20 and 35 kiloGrays, and reheated to their orientation temperature, and then oriented at a ratio of up to 1.5:1, or up to 2:1, or up to 3:1, or up to 4:1, or up to 5:1 in each of the longitudinal (also called machine-direction) and transverse (also called cross-direction) directions. In one embodiment, the orientation is about 5:1 in the traverse direction and about 10:1 in the longitudinal direction. In another embodiment the orientation is about 7:1 in each of the longitudinal and transverse directions.

The substrate films may be made by any suitable process, including coextrusion, lamination, extrusion coating, or corona bonding, and may be made by tubular cast coextrusion, such as that shown in U.S. Pat. No. 4,551,380 (Schoenberg). Bags made from the film may be made by any suitable process, such as that shown in U.S. Pat. No. 3,741,253 (Brax et al.). Side or end sealed bags may be made from single wound or double wound films.

Substrate films may be oriented by any suitable process, including a trapped bubble process or a simultaneous or sequential tenter frame process. Films may have any total thickness desired, so long as the film provides the desired properties for the particular packaging operation in which the films are used. Final film thicknesses may vary, depending on process, end use application, etc. Typical thicknesses range from 0.1 to 20 mils, preferably 0.2 to 15 mils, more preferably 0.3 to 10 mils, more preferably 0.3 to 5 mils, more preferably 0.3 to 2 mils, such as 0.3 to 1 mil.

Those having ordinary skill in the art will appreciate that a number of substrates may be used. References cited above disclose a number of suitable substrates. In addition to those disclosed, which include, but are not limited to oriented and non-oriented polyolefins, oriented polyesters, and/or oriented nylon may also be used.

Drying Conditions

Once the dispersion is coated onto the desired substrate, the coating is dried to remove the water and to coalesce the polymer particles into a substantially continuous film. In one embodiment, an oven may be used to accelerate the drying process. To properly coalesce the polymer particles, the coating is preferably allowed to reach a temperature approximately 20° C. above the melting point of the polymer from which the dispersion is produced.

In selected embodiments, the temperature range used ranges from the peak melting point of the base polymer of the dispersion to the softening point of the base film. In certain embodiments, the coated substrate may exit the drying oven at a temperature from 10° C. above the peak melting point of the base polymer of the dispersion to 10° C. below the softening point of the base film. In other embodiments the substrate may exit the drying oven at a temperature from 20° C. above the peak melting point of the base polymer of the dispersion to 20° C. below the softening point of the base film.

### EXAMPLE

100 parts by weight of a thermoplastic ethylene/acrylic acid copolymer with an acrylic acid content of 20.5 wt %, a density of about 0.958 g/cm3 (ASTM D-792) and a melt index of 13.5 g/10 min. (as determined according to ASTM D1238 at 125° C. and 2.16 kg) a Mw/Mn of about 3.7, and a melting point of about 77° C. (as determined by DSC at a scanning rate of about 10° C. per minute), commercially available as PRIMACOR 59801 from The Dow Chemical Company, is melt kneaded at 125° C. in twin screw extruder at a rate of 9.1 kg/hr.

To the melt kneaded resin, 45 wt.% aqueous solution of potassium hydroxide is continuously fed into a downstream injection port at a rate 1.8 kg/hr (at a rate of 16.5 wt % of the total mixture). The resultant aqueous dispersion is subsequently diluted with additional water at a rate of 26.9 kg/hr before exiting the extruder. An aqueous dispersion having a solids content of 26.6 wt %, a pH of 9.9, and a Brookfield viscosity of 224 cp (RV3 spindle, 21.5° C., 50 rpm) is thus obtained.

A corona treated BOPP film (BICOR LBW made by Mobil Chemical Corporation) of 1.2 mils thickness is cut into 12 inch by 14 inch sheets. Each of the sheets is taped to a flat foamed plastic board and the dispersion described above is coated onto the BOPP (the side without a slip additive) using a #4 wire-round rod. The purpose of the foamed plastic board is to achieve a more consistent coating thickness. Coated sheets are placed into a convection oven at 135° C. for 5 minutes to dry the dispersion coating. The resulting coating thickness is determined gravimetrically. Ten pieces (1-inch by 1-inch) of coated film samples are weighed individually and the coating thickness is determined by subtracting the weight of the base BOPP substrate. A density of 0.99 g/cc is used for calculating the coating thickness based on the weight difference. The coating thickness is determined to be 1.6 g/m².

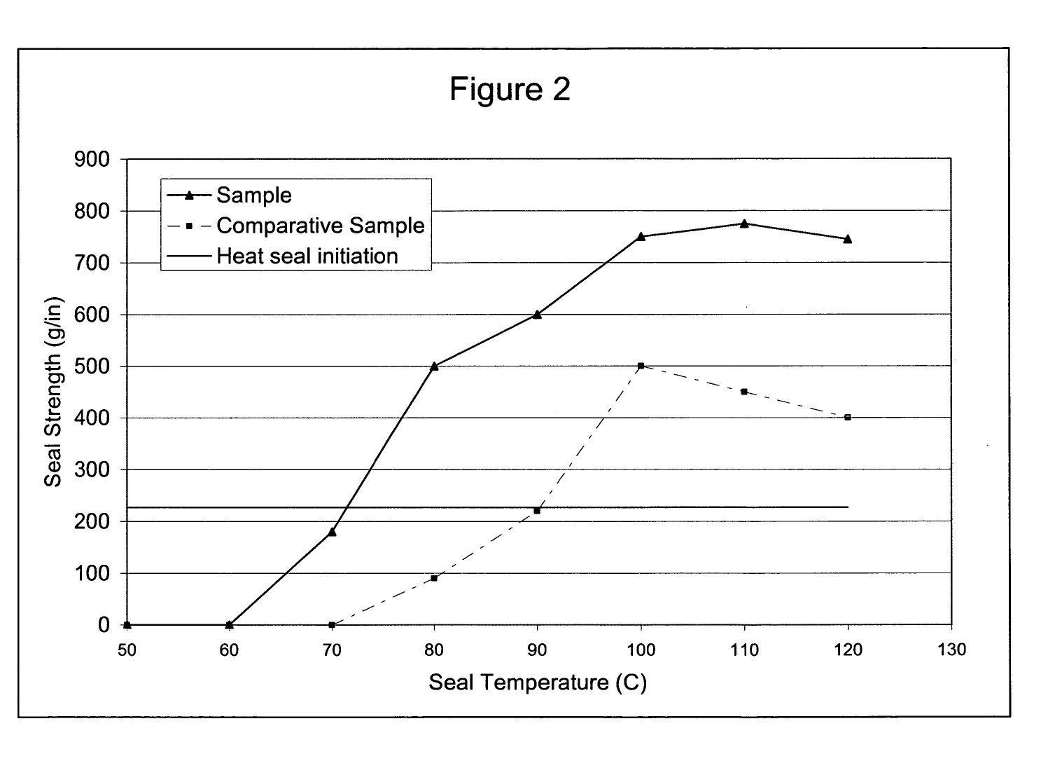

For the coated Sample above, individual strips (I inch wide) having no backing are heat sealed from 50 to 140° C. in 10° C. increments, using a Packforsk Hot Tack Tester set at 40 psi seal pressure and 0.5 second dwell time. Sealed samples are allowed to equilibrate for at least one day in an ASTM room set at 70° F. (21.1° C.) and 50% relative humidity before being pulled on an Instron model 4501 tensile testing device at a rate of 10 inches per minute. As used herein, heat seal initiation temperature is defined as the temperature at which a seal strength of 227 g/in (0.5 lb/in) is achieved. The heat seal initiation temperature for the coating in this Sample set is approximately 70° C., as shown in FIG. 2.

### Comparative Example

A corona treated BOPP (BICOR LBW made by Mobil Chemical Corporation) of 1.2 mils is cut into 12 inch by 14 inch sheets. Each of the sheets is taped to a flat foamed plastic board and coated with an ammonia neutralized dispersion of an ethylene/acrylic acid copolymer having an acrylic acid content of 20.5 wt %, a density of about 0.958 g/cm3 (ASTM D-792) and a melt index of 13.5 g/10 min. (as determined according to ASTM D1238 at 125° C. and 2.16 kg) and supplied as MICHEM Prime 4983R from Michelman, Inc. onto the BOPP (the side without a slip additive) using a #4 wire-round rod. Coated sheets are placed into a convection oven at 135° C. for 5 minutes to dry the dispersion coating. The resulting coating thickness is determined gravimetrically. Ten pieces (1-inch by 1-inch) of coated film samples are weighed individually and the coating thickness is determined by subtracting the weight of the base BOPP substrate. A density of 0.96 g/cc is used for calculating the coating thickness based on the weight difference. The coating thickness is determined to be 1.7 g/m².

For the coated Comparative Sample above, individual strips (I inch wide) having no backing are heat sealed from 50 to 140° C. in 10° C. increments, using a Packforsk Hot Tack Tester set at 40 psi seal pressure and 0.5 second dwell time. Sealed samples are allowed to equilibrate for at least a day in an ASTM room set at 70° F. (21.1° C.) and 50% relative humidity before being pulled on an Instron model 4501 tensile testing device at a rate of 10 inches per minute. The heat seal initiation temperature for the coating in the Comparative Sample set is approximately 90° C., as shown in FIG. 2.

The heat seal strength of the coated Sample and the coated Comparative Sample are graphically compared in FIG. 2. As can be seen, the minimum seal temperature (a non-zero seal strength) occurs at a lower temperature for the coated Sample. Additionally, the seal strength for the coated Sample (1.6 g/m² thickness) is greater than the seal strength of the coated Comparative Sample (1.7 g/m² thickness) regardless of seal temperature. The coated Sample has a comparable to greater seal strength than the coated Comparative Sample over a wider temperature range. These results indicates that the coated Sample may allow for higher packaging line speeds (due to a lower heat seal initiation temperatures), and may provide the ability to seal packages over broad operating windows, than the coated Comparative Sample.

Advantageously, the present inventors have surprisingly discovered that the use of ethylene-acid copolymers greater than 80% by weight neutralized by metal bases provides improved hot tack performance, without significant negative influence on minimum seal temperatures. Surprisingly, in certain embodiments, the minimum heat seal temperature may even be lowered.

In other embodiments, the present inventors have discovered that by neutralizing an ethylene-acid copolymer by a strong base, in the absence of a weak base, to greater than about 55% by weight may result in improved hot tack performance.

Thus, advantageously, one or more embodiments of the present invention provide heat sealable films that may allow for higher packaging line speeds (due to lower heat seal initiation temperatures), provide the ability to seal packages over broad operating windows, and provide good package integrity.

In other words, one or more embodiments of the present invention provide the ability to seal packages over a broad operating window. During startup and shutdown of packaging lines, the temperature of the sealing equipment may often deviate, sometimes by a large amount, from the set point. With a packaging film having a low heat seal initiation temperature, an adequate seal may still be generated if the sealing equipment is somewhat cooler than desired.

In other embodiments, the neutralized aqueous dispersions disclosed herein may be used for any number of other applications. Those having ordinary skill in the art will appreciate that a number of applications exist for dispersions formed in accordance with the methods or compositions disclosed above. Particularly, such dispersions may find utility in any application where prior art dispersions (whether or not made with ethylene-acid copolymers) may be used.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method for forming a heat sealable coating on a substrate comprising:
coating the substrate with an aqueous polymer dispersion, wherein the aqueous polymer dispersion comprises (A) an ethylene-acid copolymer; (B) a strong base, having a pKA of greater than about 10; and (C) water, wherein the strong base is the sole neutralizing agent and is present in an amount sufficient to neutralize greater than 55% by weight of the carboxyl groups in component (A); and
removing at least a portion of the water in the dispersion to form a first layer.

2. The method of claim 1, wherein the first layer has a thickness of 0.5 to 75 microns.

3. The method of claim 2, wherein the first layer has a thickness of 0.5 to 25 microns.

4. The method of claim 3, wherein the first layer has a thickness of 0.75 to 2 microns.

5. The method of claim 1, wherein the substrate comprises an oriented polymer.

6. The method of claim 1, wherein the strong base comprises at least one metal ion selected from groups Ia, IIa, or IIb of the Periodic Table.

7. The method of claim 6, wherein the strong base comprises a group Ia salt.

8. The method of claim 1, wherein the ethylene-acid copolymer comprises at least one of an ethylene-acrylic acid copolymer and an ethylene-methacrylic acid copolymer.

9. The method of claim 1, wherein the dispersion further comprises microcrystalline wax.

10. The method of claim 1, wherein the dispersion has a viscosity of less than 500 cP (RV3 spindle, 21.5° C., 50 rpm).

11. The method of claim 1, wherein the dispersion comprises 20 weight percent or more of component (A).

12. The method of claim 1, wherein the strong base is present in an amount sufficient to neutralize greater than 80% by weight of the carboxyl groups in component (A).

13. The method of claim 1, wherein the first layer has a heat seal initiation temperature equal to or less than 80° C.

14. The method of claim 1, wherein the first layer has a seal strength of at least 170 g/in at a seal temperature of 70° C. and at a thickness of between 1 and 2 microns.

15. The method of claim 1, wherein the first layer has a seal strength of at least 400 g/in at a seal temperature of 80° C. and at a thickness of between 1 and 2 microns.

16. A film comprising:
a substrate; and
a coating, wherein the coating was obtained from:
a dispersion of an ethylene-acid copolymer, wherein greater than about 55% by weight of the carboxyl groups are neutralized with at least one metal ion selected from groups Ia, IIa, or IIb of the Periodic Table.

17. The film of claim 16, wherein the coating has a thickness of 0.5 to 75 microns.

18. The film of claim 17, wherein the coating has a thickness of 0.5 to 25 microns.

19. The film of claim 16, wherein the coating has a thickness of 0.75 to 2 microns.

20. The film of claim 16, wherein the substrate comprises an oriented polymer.

21. The film of claim 16, wherein the ethylene-acid copolymer comprises at least one of an ethylene-acrylic acid copolymer and an ethylene-methacrylic acid copolymer.

22. The film of claim 16, wherein the coating further comprises microcrystalline wax.

23. The film of claim 16, wherein greater than about 80% by weight of the carboxyl groups are neutralized with at least one metal ion selected from groups Ia, IIa, or IIb of the Periodic Table.

24. The film of claim 16, wherein the coating has a heat seal initiation temperature equal to or less than 80° C.

25. The film of claim 16, wherein the coating has a seal strength of at least 170 g/in at a seal temperature of 70° C. and at a thickness of between 1 and 2 microns.

26. The film of claim 16, wherein the coating has a seal strength of at least 400 g/in at a seal temperature of 80° C. and at a thickness of between 1 and 2 microns.

27. A dispersion comprising:
(A) an ethylene-acid copolymer;
(B) a neutralizing agent; and
(C) water, wherein the neutralizing agent is present in an amount sufficient to neutralize greater than 55% by weight of the carboxyl groups in component (A).

28. The dispersion of claim 27, wherein the neutralizing agent comprises at least one metal ion selected from groups Ia, IIa, or IIb of the Periodic Table

29. The dispersion of claim 28, wherein the neutralizing agent comprises a group Ia salt.

30. The dispersion of claim 27, wherein the ethylene-acid copolymer comprises at least one of an ethylene-acrylic acid copolymer and an ethylene-methacrylic acid copolymer.

31. The dispersion of claim 27, wherein the dispersion further comprises microcrystalline wax.

32. The dispersion of claim 27, wherein the dispersion has a viscosity of less than 500 cP (RV3 spindle, 21.5° C., 50 rpm).

33. The dispersion of claim 27, wherein the dispersion comprises 20 weight percent or more of component (A).

34. The dispersion of claim 27, wherein the dispersion comprises 25 weight percent or more of component (A).

35. The dispersion of claim 27, wherein the strong base is present in an amount sufficient to neutralize greater than 80% by weight of the carboxyl groups in component (A).

36. A method for neutralizing a dispersion comprising:
adding a strong base having a pKA of about 10 or greater, in the absence of a weak base, to a mixture comprising an ethylene-acid copolymer and water, in an amount sufficient to neutralize greater than 55% by weight of the carboxyl groups in the ethylene-acid copolymer.

37. The method of claim 36, wherein the strong base is added in an amount sufficient to neutralize greater than 80% by weight of the carboxyl groups in the ethylene-acid copolymer.

38. The method of claim 36, wherein the strong base comprises at least one metal ion selected from groups Ia, IIa, or IIb of the Periodic Table.

39. The method of claim 38, wherein the strong base comprises a group Ia salt.

40. The method of claim 36, wherein the ethylene-acid copolymer comprises at least one of an ethylene-acrylic acid copolymer and an ethylene-methacrylic acid copolymer.

41. The method of claim 36, further comprises adding microcrystalline wax to the mixture.

42. A dispersion comprising:
(A) an ethylene-acid copolymer;
(B) a strong base, having a pKa of about 10 or greater;
(C) water, wherein the strong base is the sole neutralizing agent and is present in an amount sufficient to neutralize greater than 55% by weight of the carboxyl groups in component (A).

43. The dispersion of claim 42, wherein the neutralizing agent comprises at least one metal ion selected from groups Ia, IIa, or IIb of the Periodic Table

44. The dispersion of claim 43, wherein the neutralizing agent comprises a group Ia salt.

45. The dispersion of claim 42, wherein the ethylene-acid copolymer comprises at least one of an ethylene-acrylic acid copolymer and an ethylene-methacrylic acid copolymer.

46. The dispersion of claim 42, wherein the dispersion further comprises microcrystalline wax.

47. The dispersion of claim 42, wherein the dispersion has a viscosity of less than 500 cP (RV3 spindle, 21.5° C., 50 rpm).

48. The dispersion of claim 42, wherein the dispersion comprises 20 weight percent or more of component (A).

49. The dispersion of claim 42, wherein the dispersion comprises 25 weight percent or more of component (A).

50. The dispersion of claim 42, wherein the strong base is present in an amount sufficient to neutralize greater than 80% by weight of the carboxyl groups in component (A).
